(19) United States
(12) Patent Application Publication
(10) Pub. No.: US 2010/0183150 A1
(43) Pub. Date: Jul. 22, 2010

(54) Shared key management method, shared key generating method and message communication method for scada system, and recording medium

(75) Inventors: Sung-jin Lee, Gyeonggi-do (KR); Seung-joo Kim, Gyeonggi-do (KR); Dong-ho Won, Gyeonggi-do (KR); Dong-hyun Choi, Gyeonggi-do (KR); Kwang-woo Lee, Gyeonggi-do (KR); Byung-hee Lee, Gyeonggi-do (KR); Han-jae Jeong, Gyeonggi-do (KR); Woong-ryul Jeon, Gyeonggi-do (KR); Soon-haeng Hur, Gyeonggi-do (KR); Wook-jae Cha, Gyeonggi-do (KR); Sung-kyu Cho, Gyeonggi-do (KR); Hyun-sang Park, Gyeonggi-do (KR); Hyoung-seob Lee, Gyeonggi-do (KR); Hyun-seung Lee, Gyeonggi-do (KR); Song-yi Kim, Gyeonggi-do (KR); Young-jun Cho, Gyeonggi-do (KR)

Correspondence Address: Stevens Law Group, 1754 Technology Drive, Suite #226, San Jose, CA, 95110, US

(73) Assignee: The Industry & Academic Cooperation in Chungnam National University(IAC), Daejeon (KR)

(21) Appl. No.: 12/384,173

(22) Filed: Mar. 31, 2009

(30) Foreign Application Priority Data
Jan. 19, 2009 (KR) 10-2009-0004213

(51) Int. Cl. H04L 9/08

(52) U.S. Cl. 380/255; 380/278; 380/44

(57) ABSTRACT

A shared key management method for a Supervisory Control And Data Acquisition (SCADA) system in which a master terminal unit (MTU), a plurality of sub master terminal units (SUB-MTUs), and a plurality of remote terminal units (RTUs) are configured in a sequential hierarchy, is provided. The method includes: (a) at the MTU, generating a plurality of secret keys and respectively allocating the secret keys to the RTUs; (b) at the MTU, generating a group key in a tree structure, wherein a leaf node of the tree structure corresponds to each RTU, a parent node of a node corresponding to an RTU corresponds to a SUB-RTU to which the RTU is connected, a shared key of each node of the group key is generated by hashing shared keys of all child nodes, and a shared key of a leaf node of the group key is set as a secret key of the RTU; (c) at the RTU or the SUM-MTU, receiving and storing shared keys of every node from a node corresponding to itself to a root node; (d) when the RTU or the SUM-MTU is added or deleted, at the MTU, generating shared keys of nodes along a path from a node corresponding to the added or deleted terminal unit to the root node again; and (e) at the RTU or the SUB-MTU, receiving and storing the generated shared keys. According to the key management method for the SCADA system described above, in the case of encrypting and broadcasting or multicasting a message, a computation amount can be reduced.

### CROSS-REFERENCE TO RELATED APPLICATION

This application claims priority to and the benefit of Korean Patent Application No. 10-2009-0004213, filed on Jan. 19, 2009, the disclosure of which is incorporated herein by reference in its entirety.

### BACKGROUND

1. Field of the Invention

The present invention relates to a shared key management method for a Supervisory Control and Data Acquisition (SCADA) system in which a master terminal unit (MTU), a plurality of sub master terminal units (SUB-MTUs), and a plurality of remote terminal units (RTU) are configured in a sequential hierarchical structure, a group key is generated in a tree structure, an RTU or a SUB-MTU stores shared keys of every node from a node corresponding to itself to a root node, and communication is performed using the shared keys.

Particularly, the present invention relates to a shared key management method for a SCADA system in which a group key is generated in a tree structure, one group key is generated in a structure in which a leaf node and a parent node of a leaf node correspond to an RTU and a SUB-MTU, or group keys are generated for a group of a MTU and SUB-MTUs and for a group of a SUB-MTU and RTUs connected thereto, and the separate groups communicate through an Iolus framework.

The present invention also relates to a shared key management method in which when an RTU or a SUB-MTU is added or deleted, a tree structure of a corresponding group key is changed, and a shared key of the changed tree structure is updated and re-distributed.

2. Discussion of Related Art

A Supervisory Control and Data Acquisition (SCADA) system is an industrial control and monitoring system used in areas such as national infrastructure. For example, a SCADA system is a computer system which monitors and controls processes of water resource facilities, energy facilities such as electric power stations and electric power substations, and gas and oil pipelines.

In the past, SCADA systems were used in closed environments and so were designed without considering security functionality. As the need to connect SCADA systems to open networks gradually increased, SCADA system security became an issue. In order to improve SCADA system security, a data encryption function and encryption key management are indispensable.

As conventional key management methods for a SCADA system, SKE (Key establishment for SCADA systems) and SKMA (Key management scheme for SCADA systems) have been suggested. However, SKE and SKMA have a disadvantage in that they cannot support broadcasting and multicasting communication. That is, in order to transmit a message to many devices, SKE and SKMA encrypt a message with a key shared with each device as many times as the number of devices. Thus, the schemes put a heavy load on a SCADA system which has to manage thousands of devices and perform real-time processing, and thus are not inefficient methods.

An improved key management scheme for a secure communication environment of a SCADA system which solves the above problem through a logical key with a hierarchical structure has been suggested. However, the improved key management scheme has a problem in that a lot of computations are required, which is a fatal drawback for a SCADA system which has to perform real-time processing.

### SUMMARY OF THE INVENTION

The present invention is directed to a key management method for a Supervisory Control and Data Acquisition (SCADA) system in which a master terminal unit (MTU), a plurality of sub master terminal units (SUB-MTUs), and a plurality of remote terminal units (RTU) are configured in a sequential hierarchical structure, a group key is generated in a tree structure, an RTU or a SUB-MTU stores shared keys of every node from a node corresponding to itself to a root node, and communication is performed using the shared keys.

The present invention is also directed to a key management method for a SCADA system in which a group key is generated in a tree structure, one group key is generated in a structure in which a leaf node and a parent node of a leaf node correspond to an RTU and a SUB-MTU, or group keys are generated for a group of a MTU and SUB-MTUs and for a group of a SUB-MTU and RTUs connected thereto, and the separate groups communicate through an Iolus framework.

The present invention is also directed to a key management method in which when an RTU or a SUB-MTU is added or deleted, a tree structure of a corresponding group key is changed, and a shared key of the changed tree structure is updated and re-distributed.

According to an aspect of the present invention, there is provided a shared key management method for a Supervisory Control And Data Acquisition (SCADA) system in which a master terminal unit (MTU), a plurality of sub master terminal units (SUB-MTUs), and a plurality of remote terminal units (RTUs) are configured in a sequential hierarchy, the method including: (a) at the MTU, generating a plurality of secret keys and respectively allocating the secret keys to the RTUs; (b) at the MTU, generating a group key in a tree structure, wherein a leaf node of the tree structure corresponds to each RTU, a parent node of a node corresponding to an RTU corresponds to a SUB-RTU to which the RTU is connected, a shared key of each node of the group key is generated by hashing shared keys of all child nodes, and a shared key of a leaf node of the group key is set as a secret key of the RTU; (c) at the RTU or the SUM-MTU, receiving and storing shared keys of every node from a node corresponding to itself to a root node; (d) when the RTU or the SUM-MTU is added or deleted, at the MTU, generating shared keys of nodes along a path from a node corresponding to the added or deleted terminal unit to the root node again; and (e) at the RTU or the SUB-MTU, receiving and storing the generated shared keys.

In step (a), the MTU may generate a shared key and allocate the shared key to a SUB-MTU to which no RTU is connected, and in step (b), the SUB-MTU to which no RTU is connected may correspond to a leaf node of the tree structure.

The tree structure may be a binary tree up to a node corresponding to a SUB-MTU, and an n-array tree from the SUB-MTU to an RTU.

Step (d) may include (d1) when the RTU is added or deleted, at a node corresponding to a SUB-MTU to which the added or deleted RTU is connected, adding or deleting a node corresponding to the added or deleted RTU; (d2) when the SUB-MTU is added or deleted, adding or deleting a node corresponding to the added or deleted SUB-MTU to or from the tree structure of the group key and reconfiguring the tree structure of the group key as a binary tree; and (d3) generating shared keys of nodes along a path from the added or deleted node to the root node again.

In step (d2), when the SUB-MTU is added, the MTU may generate a node corresponding to the added SUB-MTU, exclude one leaf node from the tree structure of the group key, generate an intermediate node which has the added node and the excluded leaf node as child nodes, and connect the intermediate node to a location at which the excluded leaf node is located before exclusion, and when the SUB-MTU is deleted, the MTU may delete a node corresponding to the deleted SUB-MTU from the tree structure of the group key and place a sibling of the deleted node at a location of a parent node of the deleted node.

In step (e), the MTU may encrypt the generated shared keys with previous shared keys and multicast the encrypted shared keys to the RTU or the SUB-MTU, and the RTU or the SUB-MTU may receive and decrypt the encrypted shared key and store the decrypted shared key.

According to another aspect of the present invention, there is provided a shared key management method for a Supervisory Control And Data Acquisition (SCADA) system in which a master terminal unit (MTU), a plurality of sub master terminal units (SUB-MTUs), and a plurality of remote terminal units (RTUs) are configured in a sequential hierarchy, the method including: (a) at the MTU, generating a plurality of secret keys and respectively allocating the secret keys to the SUB-MTUs, and at the SUB-MTUs, generating a plurality of secret keys and respectively allocating the secret keys to the RTUs belonging to the SUB-MTUs; (b) at the MTU, generating a group key of the SUB-MTUs in a tree structure, and at the SUB-MTUs, generating a group key of the RTUs belonging to the SUB-MTUs, wherein a leaf node of the tree structure corresponds to each RTU or each SUB-MTU, a shared key of each node of the group key is generated by hashing shared keys of all child nodes, and a shared key of a leaf node of the group key is set as a secret key of the RTU or the SUB-MTU; (c) at the RTU or the SUM-MTU, receiving and storing shared keys of every node from a node corresponding to itself to a root node; (d) when the RTU or the SUM-MTU is added or deleted, at the MTU or the SUB-MTU, generating shared keys of nodes along a path from a node corresponding to the added or deleted terminal unit to the root node again; and (e) at the RTU or the SUB-MTU, receiving and storing the generated shared keys.

The tree structure may be a binary tree.

Step (d) may include: (d1) when the RTU or the SUB-MTU is added or deleted, adding or deleting a node corresponding to the added or deleted RTU or SUB-MTU to or from the tree structure of the group key and reconfiguring the tree structure of the group key as a binary tree; and (d2) generating shared keys of nodes along a path from the added or deleted node to the root node again.

In step (d2), when the SUB-MTU or the RTU is added, the MTU or the SUB-MTU may generate a node corresponding to the added SUB-MTU or RTU, exclude one leaf node from the tree structure of the group key, generate an intermediate node which has the added node and the excluded leaf node as child nodes, and connect the intermediate node to a location at which the excluded leaf node is located before exclusion, and when the SUB-MTU or the RTU is deleted, the MTU or the SUB-MTU may delete a node corresponding to the deleted SUB-MTU or RTU from the tree structure of the group key and place a sibling of the deleted node at a location of a parent node of the deleted node.

In step (e), the MTU or the SUB-MTU may encrypt the generated shared keys with previous shared keys and multicast the encrypted shared keys to the SUB-MTUs or the RTUs, and the SUB-MTUs or the RTUs may receive and decrypt the encrypted shared key and store the decrypted shared key.

According to still another aspect of the present invention, there is provided a recording medium storing the shared key management method for the SCADA system.

According to yet another aspect of the present invention, there is also provided a session key generating method for a Supervisory Control And Data Acquisition (SCADA) system in which a master terminal unit (MTU), a plurality of sub master terminal units (SUB-MTUs), and a plurality of remote terminal units (RTUs) are configured in a sequential hierarchy, the method including: generating a session key using a group key configured by the shared key management method.

The session key may be generated by hashing the group key and a value in which a timestamp and a sequence number are combined.

According to yet another aspect of the present invention, there is also provided a message communication method for a Supervisory Control And Data Acquisition (SCADA) system in which a master terminal unit (MTU), a plurality of sub master terminal units (SUB-MTUs), and a plurality of remote terminal units (RTUs) are configured in a sequential hierarchy, the method including: performing message communication between a group of the MTU and the SUB-MTUs and a group of the SUB-MTUs and the RTUs through an Iolus framework by using a group key configured by the shared key management method.

When the SUB-MTUs receive a message encrypted using a group key of the SUB-MTUs, the SUB-MTUs may decrypt the encrypted message using a group key, encrypt the decrypted message using a shared key of a root node of a group key of RTUs belonging to the SUB-MTUs, and multicast the encrypted message to RTUs belonging to the SUB-MTUs.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a view illustrating a configuration a SCADA system according to the present invention;

FIG. 2 is a flowchart illustrating a shared key management method for a SCADA system according to a first exemplary embodiment of the present invention;

FIG. 3 is a view illustrating a tree structure of a group key generated according to the first exemplary embodiment of the present invention;

FIG. 4 is a flowchart illustrating a procedure for generating a shared key again when an RTU or a SUB-MTU is added or deleted according to the first exemplary embodiment of the present invention;

FIG. 5 is a view illustrating a tree structure of a group key reconfigured when a SUB-MTU is added according to the first exemplary embodiment of the present invention;

FIG. 6 is a view illustrating a tree structure of a group key reconfigured when a SUB-MTU is deleted according to the first exemplary embodiment of the present invention;

FIG. 7 is a flowchart illustrating a shared key management method for a SCADA system according to a second exemplary embodiment of the present invention;

FIG. 8 is a view illustrating a tree structure of a group key generated according to the second exemplary embodiment of the present invention; and

FIGS. 9A and 9B are views illustrating effects of the key management method according to the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

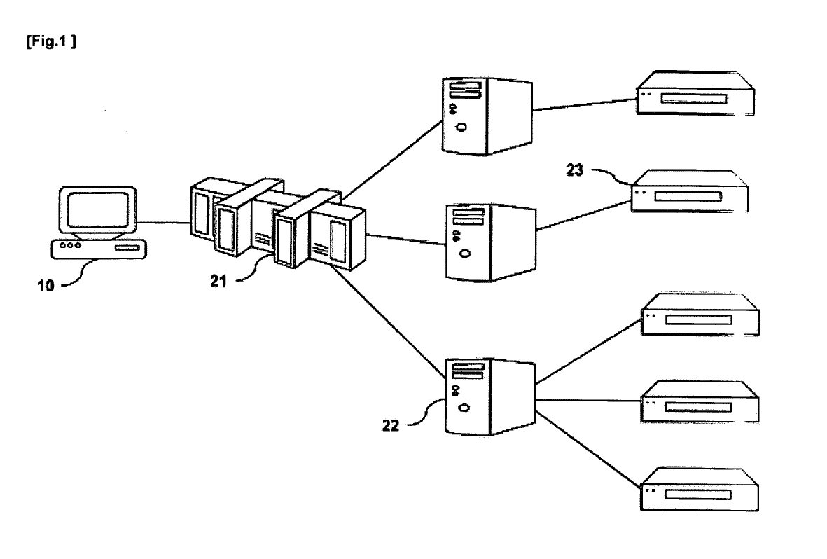

First, a configuration of a SCADA system according to the present invention will be described with reference to FIG. 1.

As shown in FIG. 1, a SCADA system according to the present invention includes a human-machine interface (HMI) 10, a master terminal unit (MTU) 21, a sub master terminal unit (SUB-MTU) 22, and a remote terminal unit (RTU) 23. The MTU 21, the SUB-MTU 22, and the RTU 33 have a sequential hierarchical structure.

The HMI 10 is an apparatus which shows process data of the infrastructure to an operator and is also a terminal apparatus through which an operator monitors and controls an infrastructure. To this end, the HMI 10 includes a terminal apparatus having a computing function.

The RTU 23 is a terminal apparatus which is installed in an infrastructure to collect and transmit process data or to perform a control operation according to a control command. Commonly, since infrastructures applied to a SCADA system are distributed across a wide region, the RTUs 23 are also regionally scattered.

The SUB-MTU 22 communicates with corresponding RTUs 23 and controls the corresponding RTUs 23. The MTU 21 is an apparatus which collects process data and performs control in general. That is, the MTU 21 controls the SUB-MTUs 22, and monitors and controls the RTUs 23 through the SUB-MTUs 22.

The MTU 21, the SUB-MTU 22, and the RTU 23 use a session key for encrypted communication. That is, a session key is generated and shared between a transmitting terminal unit and a receiving terminal unit. The transmitting terminal unit encrypts a transmission message with a session key and transmits the encrypted message, and the receiving terminal unit receives the encrypted message and decrypts the encrypted message with a session key.

A session key is a key used only in a certain session for transmitting/receiving a message, and a different session key is generated when a session is changed. Even if a session key corresponding to a certain session is exposed, a different session is secure. A secret key used to generate a session key is a shared key. A session key is generated by appending a timestamp, a sequence number, and a device identifier to a shared key. Therefore, it is very important to manage a shared key for secure communication.

As a shared key management method for a SCADA system according to the present invention, a first exemplary embodiment in which the MTU 21 manages a shared key in one logical structure in general, and a second exemplary embodiment in which the MTU terminal and the SUB-MTU 22 manage a shared key in discrete logical structures, will be described below.

According to the first exemplary embodiment of the present invention, the MTU 21 generates a shared key and transmits the shared key to the SUB-MTUs 22 or the RTUs 23. That is, the MTU 21 controls a shared key in general, and a shared key is shared by all terminal units.

According to the second exemplary embodiment of the present invention, the MTU 21 generates a shared key and transmits the shared key to the SUB-MTUs 22 under its control, and the SUB-MTU 22 also generates a shared key and transmits the shared key to the RTUs 22 under its control. That is, the MTU 21 and the SUB-MTU 22 manages a shared key in two classes. Different shared keys are respectively shared between the MTU 21 and the SUB-MTU 22 and between the SUB-MTU 22 and the RTU 23.

Here, the MTU 21 and the SUB-MTUs 22 which belong to the MTU 21 are referred to as a “master class group”, and the SUB-MTU 22 and the RTUs 23 which belong to the SUB-MTU 22 are referred to as a “sub class group”.

The SUB-MTU 22 uses a session key generated in a master class group when performing communication within a master class group, and uses a session key generated in a sub class group when performing communication within a sub class group. The session key is generated using a shared key which is generated and managed in each group.

A master class group and a sub class group communicate messages with each other through Iolus framework. In the case of transmitting a message from a master class group to a sub class group, the SUB-MTU 22 decrypts a received message with a session key generated in a master class group, and encrypts the decrypted message with a session key generated in a sub class group again and transmits the encrypted message to a sub class group. In the case of transmitting a message from a sub class group to a master class group, the SUB-MTU 22 performs reverse processing.

Meanwhile, when the SUB-MTU 22 or the RTU 23 is deleted from or added to the SCADA system, the structure of the SCADA system of FIG. 1 is changed. When the structure of the SCADA system is changed, a shared key is also changed.

That is, the MTU 21 in the case of the first exemplary embodiment, and the MTU 21 or the SUB-MTU 22 in the case of the second exemplary embodiment, update a shared key according to the changed structure of the SCADA system and transmit the updated shared key to the SUB-MTUs 22 or the RTUs 23.

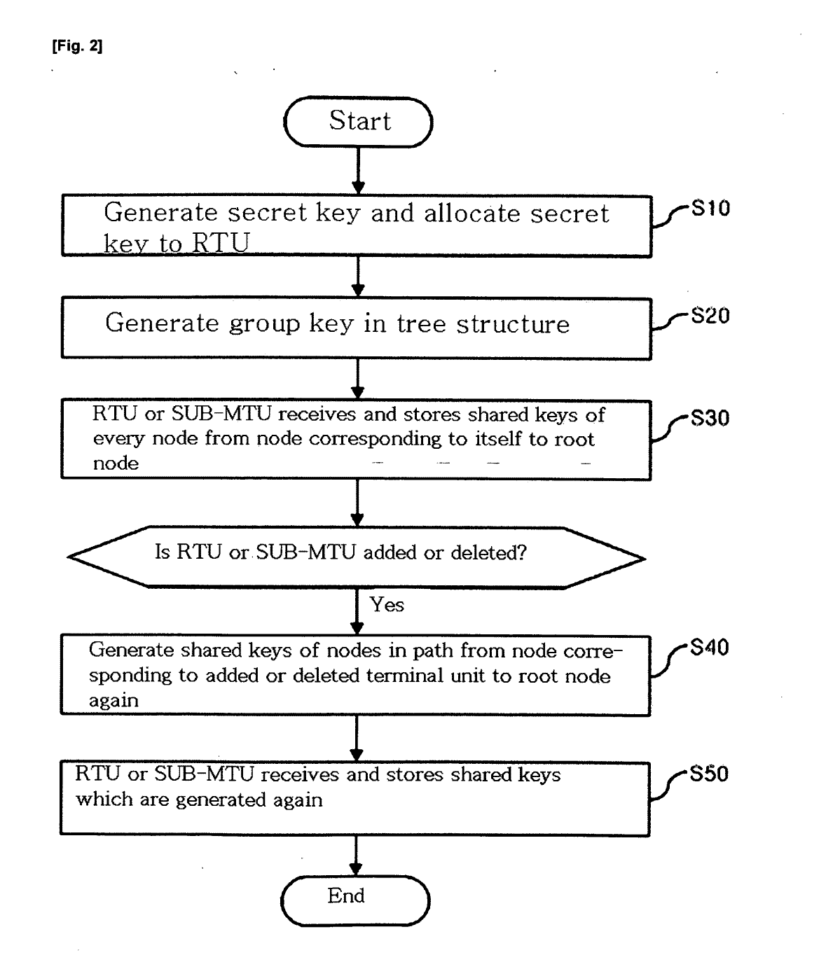

Next, a shared key management method for a SCADA system according to the first exemplary embodiment of the present invention will be described with reference to FIG. 2.

As shown in FIG. 2, the key management method according to the first exemplary embodiment of the present invention includes: (a) at an MTU, generating a secret key and allocating the generated secret key to an RTU (S10); (b) at the MTU, generating a group key in a tree structure, wherein a shared key of each node of the group key is generated by hashing shared keys of all child nodes, and a shared key of a leaf node of the group key is set as a secret key of the RTU (S20); (c) at the RTU or a SUM-MTU, receiving and storing shared keys of every node from a node corresponding to itself to a root node (S30); (d) if the RTU or the SUM-MTU is added or deleted, at the MTU, generating shared keys of nodes along a path from a node corresponding to the added or deleted terminal unit to the root node again (S40); and (e) at the RTU or the SUB-MTU, receiving and storing the generated shared key (S50).

In step (a), the MTU 21 generates a plurality of secret keys and respectively allocates the shared keys to the corresponding RTUs 23 (S10). The MTU 21 also generates a shared key and allocates the shared key to the SUB-MTUs 22 to which the RTU 23 is not connected.

That is, the MTU 21 generates a shared key and allocates the shared key to the SUB-MTUs 22 or the RTUs 23 which correspond to an end node, that is, a leaf node, in the hierarchical structure of the SCADA system.

In step (b), the MTU 21 generates a group key in a tree structure. Here, a leaf node of the tree structure corresponds to each RTU 23, a parent node of a node corresponding to the RTU 23 corresponds to the SUB-MTU 22 to which the RTU 23 is connected, a shared key of each node of the group key is generated by hashing shared keys of all child nodes, and a shared key of a leaf node of the group key is set as a secret key of the RTU 23 (S20).

Particularly, a tree structure of the group key is a binary tree up to a node corresponding to the SUB-MTU 22 and an n-array tree from the SUB-MTU 22 to the RTU 23.

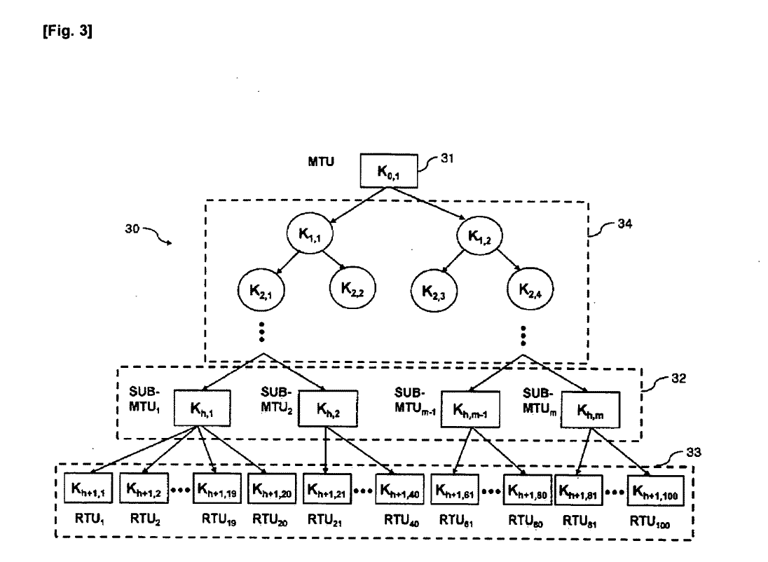

A tree structure of a group key 30 according to the first exemplary embodiment of the present invention will be described in more detail with reference to FIG. 3.

As shown in FIG. 3, the group key 30 has a tree structure corresponding to the SCADA system. A root node 31 of the group key 30 corresponds to the MTU 21, and a leaf node 33 corresponds to the RTU 23. The root node and the leaf node are referred to as “MTU node 31” and “RTU node 32”, respectively.

A parent node 32 of the leaf node 33 corresponds to the SUB-MTU 22. The parent node 32 is referred to as “SUB-MTU node 33”. The child nodes 33 of one SUB-MTU node 32 correspond to the RTUs 23 connected to the SUB-MTU 22. Therefore, a structure of the nodes corresponding to the SUB-MTU or the RTU is the same as the hierarchical structure of the SCADA system. Also, since a plurality of RTUs 23 can be connected to the SUB-MTU 22, a tree in which a node corresponding to the SUB-MTU 22 is used as a root is an n-array tree.

Meanwhile, the MTU node 31 and the SUB-MTU node 32 have a binary tree structure therebetween. A node between the MTU 31 and the SUB-MTU 32 is referred to as an “intermediate node 34”.

A tree of nodes from the MTU node 31 as an apex (root node) to the SUB-MTU node 32 is a binary tree, and a tree which uses the SUB-MTU 32 as an apex is an n-array tree.

A shared key is generated in each node of a tree structure of the group key 31. A method for generating a shared key is described below.

First, a secret key allocated to each RTU 23 in step (a) is set as a shared key of the leaf node 33 (or RTU node) of the group key 30. A secret key allocated to the SUB-MTU 23 is set as a shared key of the SUB-MTU node corresponding to the SUB-MTU 23 to which no RTU is connected. That is, a secret key is set as a shared key of the leaf node of the tree structure of the group key 30. For example, in FIG. 3, secret keys K_{h+1,1}, K_{h+1,2}, . . . , K_{h+1,100} which are allocated to RTUs RTU₁, RTU₂, . . . , RTU₁₀₀ are set as shared keys of the leaf nodes of the group key 30.

Next, a shared key of each node of the group key 30 is generated by hashing shared keys of all child nodes.

A shared key of the SUB-MTU node 32 is generated by hashing secret keys of all RTUs 23 connected to the SUB-MTU 22. A shared key of the SUB-MTU 32, that is, K_{i+1, [j/n]} if (1≦i≦logₙ m−1,1≦j≦m), is generated by hashing secret keys of m RTUs, that is, K_{i,j} if (1≦i≦logₙ m−1,1≦j≦m). This can be expressed by Equation 1:

K_{i-1, [j/n]}=H(H(K_{i,j}),H(K_{i,j+1}), . . . , H(K_{i,j+n-1}))

if (1≦i≦logₙ m−1,1≦j≦m) Equation 1

Here, m denotes the number of SUB-MTUs connected to MTU, and n denotes the number of RTUs.

Meanwhile, the MTU node 31 and the SUB-MTU node 32 have a shared key structure of a binary tree form generated between them. In a binary tree structure, a shared key value of each node is generated by hashing two shared keys (or hashed values) of child nodes. This can be expressed by Equation 2:

K_{i-1, [j/2]}=H(H(K_{i,j}),H(K_{i,j+1}))

if (1≦i≦h−1,1≦j≦m)

Here, m denotes the number of RTUs, and h=1+log₂ m.

Therefore, a shared key structure of a binary tree structure is formed through the above equation, and a shared key K_{0,1} of a root node is generated.

In step (c), the RTU 23 or the SUB-MTU 22 receives and stores shared keys of every node from a node corresponding to itself to a root node (S30).

In the group key structure described in step (b), the SUB-MTU 22 stores key values of all nodes along a path from its node to a root node. That is, if the number of SUB-MTU 22 is m, the SUB-MTU 22 stores (1+log₂ m) number of shared keys, and the RTU 23 stores (2+log₂ m) number of shared keys, which includes its shared key (or secret key) plus the number of shared keys of the SUB-MTU 22.

In step (d), when the RTU 23 or the SUB-MTU 22 is added or deleted, the MTU 21 generates shared keys of nodes along a path from a node corresponding to the added or deleted terminal unit to the root node again (S40).

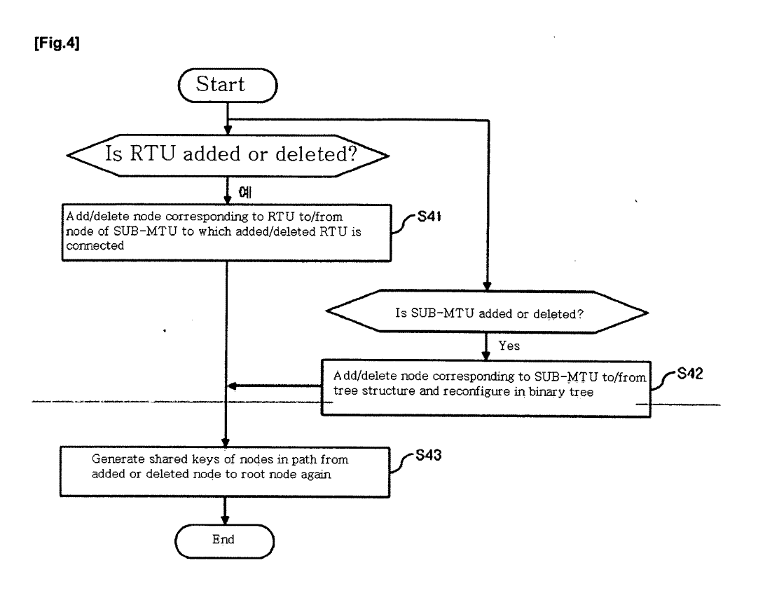

Step (d) will be described in detail with reference to FIG. 4.

As shown in FIG. 4, step (d) includes (d1) changing the group key 30 when the RTU 23 is added or deleted (S41), (d2) changing the group key 30 when the SUB-MTU 22 is added or deleted (S42), and (d3) generating shared keys of nodes according to a change of the group key 30 again (S43).

In step (d1), when the RTU 23 is added is deleted, the node 32 corresponding to the SUB-MTU to which the added or deleted RTU 23 is connected adds or deletes the node 33 corresponding to the added or deleted RTU (S41).

The SUB-MTU 22 and the RTU 23 are identical in structure to the SUB-MTU node 32 and the RTU node 33 of the group key 30. A tree structure of the SUB-MTU node 32 and the RTU node 33 is an n-array tree, and thus the number of child nodes of the SUB-MTU 22 is not limited. Therefore, when the RTU 23 is added is deleted, the SUB-MTU 22 adds or deletes the RTU node 33. At this time, no other node of the group key 30 is changed.

For example, in FIG. 3, when an RTU RTU₁₀₀ is deleted, a node K_{h+1,100} of the group key 30 corresponding to RTU₁₀₀ is deleted from the SUB-MTU node K_{h,m}. Also, in FIG. 3, when an RTU RTU₁₀₁ is added, a node K_{h+1,101} corresponding to the RTU RTU₁₀₁ is added to the SUB-MTU node K_{h,m}. Except the added or deleted terminal unit, the structure of the group key 30 of FIG. 3 is not changed.

In step (d2), when the SUB-MTU 22 is added or deleted, the node corresponding to the added or deleted SUB-MTU 22 is added to or deleted from the tree structure of the group key 30, and the tree structure of the group key 30 is reconfigured in a binary tree form (S42).

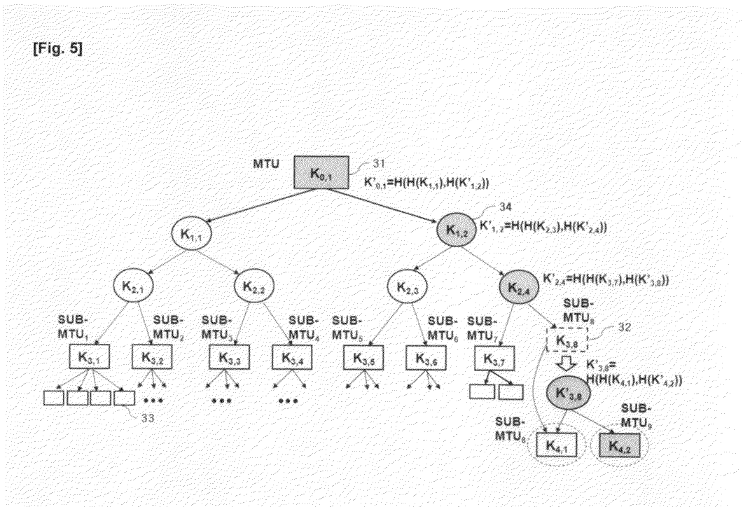

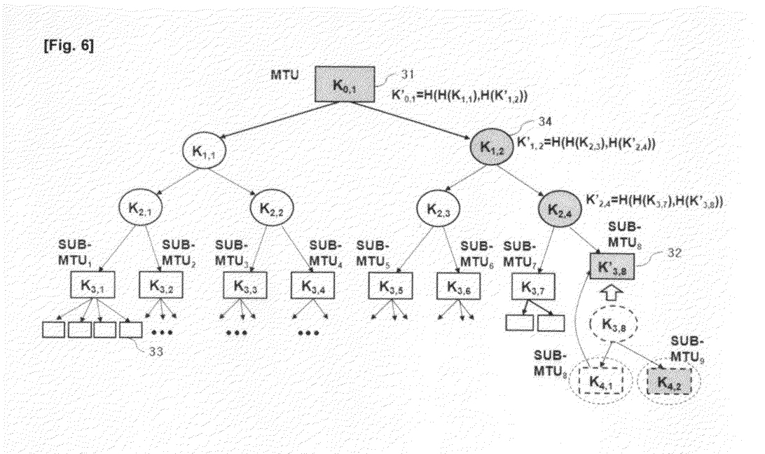

Unlike a case where the RTU 23 is added or deleted, when the SUB-MTU 22 is added or deleted, nodes of from the MTU node 31 to the SUB-MTU node 32 have to be reconfigured in a binary tree form, which will be described below with reference to FIGS. 5 and 6.

As shown in FIG. 5, in step (d2), when the SUB-MTU 22 is added, the MTU 21 generates a node corresponding to the added SUB-MTU 22, excludes one leaf node from the tree structure of the group key 30, generates an intermediate node which has the added node and the excluded leaf node as child nodes, and connects the intermediate node to a location at which the excluded leaf node is located before exclusion.

In FIG. 5, an added node corresponding to an added SUB-MTU 22 is K_{4,2}, and a location to add is K_{3,8} which is a SUB-MTU node. In order to make a binary tree by adding the added node K_{4,2}, a new intermediate node K′_{3,8} is added at a location of the SUB-MTU node K_{3,8}, and the SUB-MTU node K_{3,8} and the added node K_{4,2} are added as child nodes of the new intermediate node K′_{3,8}. At this time, the SUB-MTU node K_{3,8} is marked by a SUB-MTU node K_{4,1}.

Meanwhile, as shown in FIG. 6, in step (d2), when the SUB-MTU 22 is deleted, the MTU 21 deletes a node corresponding to the deleted SUB-MTU 22 from the tree structure of the group key 30 and places a sibling of the deleted node at a location of a parent node of the deleted node.

In FIG. 6, an added node corresponding to an added SUB-MTU 22 is K_{4,2}. When the added node K_{4,2} is deleted, only one SUB-MTU node K_{4,1} remains as a child node of the intermediate node K_{3,8}. Therefore, the remaining SUB-MTU node K_{4,1} is placed at a location of the intermediate node K_{3,8}. At this time, the SUB-MTU node K_{4,1} is marked by K′_{3,8}.

When the SUB-MTU 22 is deleted or added, the RTU connected to the added or deleted SUB-MTU 22 remains connected to the SUB-MTU 22 “as is”. Therefore, the nodes 33 which are child nodes of the added or deleted SUB-MTU node 32 remain connected “as is”. Even though child nodes of the SUB-MTU node 32 are not shown in FIGS. 5 and 6, the child nodes move together with the SUB-MTU node 32 “as is”.

In step (d3), shared keys of nodes along a path from the added or deleted node to a root node are generated again (step 43).

When the tree structure of the group key 30 is changed, a shared key of each node is generated again according to that change. A method for generating a shared key is similar to step (b) except that nodes of which a shared key is generated are nodes along a path from an added or deleted node to a root node. This is because each node hashes shared keys of all child nodes.

For example, in FIG. 5 or 6, since shared keys of child nodes of an intermediate node shared key K_{1,1} are not changed, they do not need to be updated. However, shared keys in a path up to a root node such as shared keys K_{0,1}, K_{1,2}, K_{2,4} are updated.

In step (e), the RTU 23 or the SUB-MTU 22 receives and stores the generated shared key (S50). Particularly, in step (e), the MTU 21 encrypts the generated shared key with the previous shared key and multicasts the encrypted shared key to the RTU 23 or the SUB-MTU 22, and the RTU 23 or the SUB-MTU 22 receives and decrypts the encrypted shared key and stores the decrypted shared key.

The MTU 21 encrypts the updated shared key with the most recent previous shared key and multicasts the encrypted shared key. The updated shared keys are encrypted with a shared key of a new node and a shared key of a sibling of a new node, respectively, and are then multicast to the newly added SUB-MTU 22 or RTU 23 and its sibling.

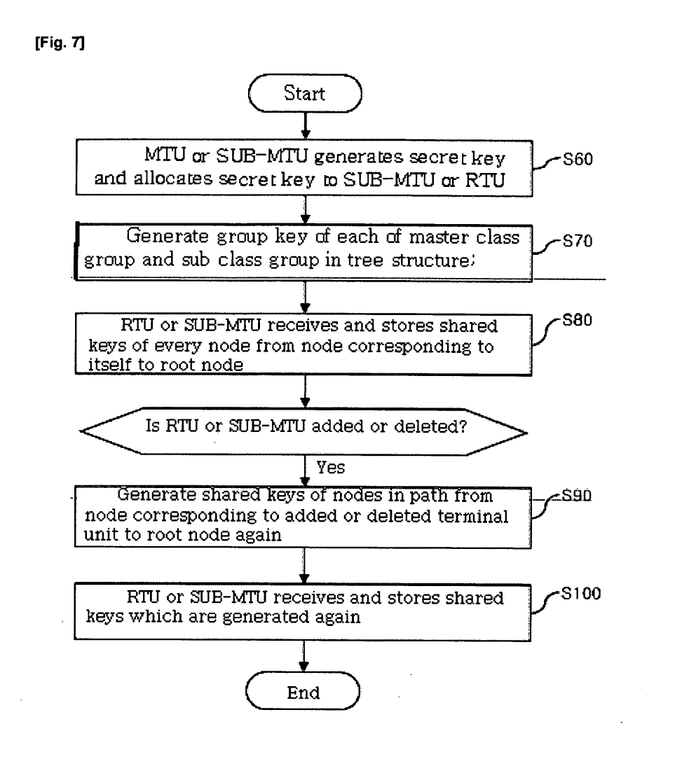

Next, a shared key management method for a SCADA system according to the second exemplary embodiment of the present invention will be described with reference to FIG. 7.

As shown in FIG. 7, a key management method according to the second exemplary embodiment of the present invention includes: (a) at a MTU or a SUB-MTU, generating a secret key and allocating the generated secret key to a SUB-MTU or an RTU (S60); (b) generating a group key of each of a master class group and a sub class group in a tree structure, wherein a shared key of a leaf node of the group key is set as a secret key of the SUB-MTU or the RTU (S70); (c) at the RTU or the SUM-MTU, receiving and storing shared keys of every node from a node corresponding to itself to a root node (S80); (d) when the RTU or the SUM-MTU is added or deleted, at the MTU or the SUB-MTU, generating shared keys of nodes along a path from a node corresponding to the added or deleted terminal unit to the root node again (S90); and (e) at the RTU or the SUM-MTU, receiving and storing the generated shared key (S100).

According to the second exemplary embodiment of the present invention, shared keys are divided and managed in the master class group which is a group of the MTU 21 and the SUB-MTU 22 belonging to the MTU 21, and the sub class group which is a group of the SUB-MTU 22 and the RTU belonging to the SUB-MTU 23.

In the master class group, the MTU 21 manages a shared key, and in the sub class group, the SUB-MTU 22 manages a shared key. In each group, a shared key of a group key is managed in the same way. A method for managing a group key is similar to a method for managing a tree structure of from an MTU node to a SUB-MTU node in the first exemplary embodiment of the present invention. Therefore, a method for managing a group key will be described below with reference to the first exemplary embodiment described above.

In step (a), the MTU 21 generates a plurality of secret keys and allocates the secret keys to the corresponding SUB-MTUs 22, respectively, and the SUB-MTU 22 generates a plurality of secret keys and allocates the secret keys to the corresponding RTUs 23 belonging to itself, respectively (S60).

In step (b), the MTU 21 generates a group key of the SUB-MTU 22 in a tree structure, and the SUB-MTU 22 generates a group key of the RTU 23 in a tree structure (S70). A leaf node of the tree structure corresponds to each RTU 23 or each SUB-MTU 22, a shared key of each node of the group key is generated by hashing shared keys of all child nodes, and a shared key of a leaf node of the group key is set as a secret key of each RTU 23 or each SUB-MTU 22 (S70).

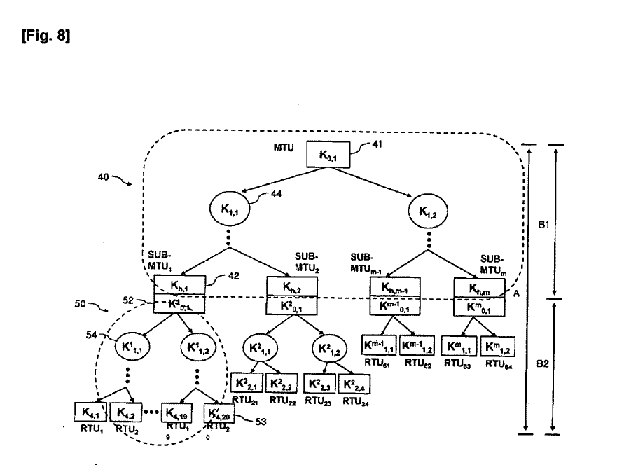

The tree structure is a binary tree. The tree structure of a group key divided into the class groups is shown in FIG. 8.

As shown in FIG. 8, a group key is divided into a master class group key 40 in which an MTU node K_{0,1} is used as a root node 41 and a sub class group key 50 in which SUB-MTU nodes K¹_{0,1}, K²_{0,1}, . . . , K^{m}_{0,1} are used as root nodes 52. Here, the number of the sub class group keys 50 is identical to the number of the SUB-MTUs 22.

A method for generating a group key is described below. As described in step (a), the MTU 21 allocates a secret key to all SUB-MTUs 22, and each SUB-MTU 22 knows its secret key. In the secret key structure, a shared key value K_{i+1, [j/2]} if (1≦i≦h−1,1≦j≦m) of a different node is generated by hashing two hashed values (shared keys) of child nodes as in Equation 2. Therefore, according to the above equation, a key structure of a binary tree form is formed, and a shared key K_{0,1} of a root node is generated.

A group key structure between the SUB-MTU 22 and the RTU 23 is generated in the same way as described above. As described step (a), the SUB-MTU 22 allocates a secret key to all RTUs 23, and each RTU 23 knows its secret key. A shared key structure between the SUB-MTU 23 and the RTU 23 is formed in a binary tree form, and a shared key value K_{i+1, [j/2]} if (1≦i≦h−1,1≦j≦m) of each node is generated by hashing two shared keys (hashed values) of child nodes as in Equation 2.

In step (c), the SUB-MTU 22 or the RTU 23 receives and stores shared keys of every node from a node corresponding to itself to a root node (S80).

In the group key structure according to the second exemplary embodiment of the present invention, the SUB-MTU 22 stores shared key values of all nodes along a path from its node to a root node which is the MTU node 41, and shared key values of all RTUs 23 managed by itself. That is, if the number of SUB-MTU 22 is m and the number of RTUs 23 managed by one SUB-MTU 22 is n, (1+n+log₂ m) number of shared keys is stored. The RTU 23 stores shared key values of all nodes along a path up to a root node which is a node of the SUB-MTU 22 which manages the RTU 23. That is, if the number of RTUs 23 managed by one SUB-MTU 22 is n, (1+log₂ n) number of shared keys are stored.

In step (d), when the SUB-MTU 22 or the RTU 23 is added or deleted, the MTU 21 or the SUB-MTU 22 generates shared keys of nodes along a path from a node corresponding to the added or deleted terminal unit to the root node again (S90).

Particularly, step (d) includes: (d1) adding or deleting a node corresponding to the added or deleted RTU 23 or SUB-MTU 22 to or from the tree structure of the group key 40 or 50 and then reconfiguring the tree structure of the group key 40 or 50 in a binary tree when the SUB-MTU 22 or the RTU 23 is added or deleted, and (d2) generating shared keys of nodes along a path from the added or deleted node to the root node again.

Meanwhile, in the second exemplary embodiment, when the SUB-MTU 22 or the RTU 23 is added or deleted, a method for generating a shared key of the group key again is the same as the method for generating the shared key again when the SUB-MTU 22 is added or deleted in the first exemplary embodiment described. above.

That is, in step (d2), when the SUB-MTU 22 or the RTU 23 is added, the MTU 21 or the SUB-MTU 22 generates a node corresponding to the added SUB-MTU 22 or RTU 23, excludes one leaf node from the tree structure of the group key, generates an intermediate node which has the added node and the excluded leaf node as child nodes, and connects the intermediate node to a location at which the excluded leaf node is located before exclusion.

In step (d2), when the SUB-MTU 22 or the RTU 23 is deleted, the MTU 21 or the SUB-MTU 22 deletes a node corresponding to the deleted SUB-MTU 22 or RTU 23 from the tree structure of the group key and places a sibling of the deleted node at a location of a parent node of the added node.

In step (e), the MTU 21 or the SUB-MTU 22 encrypts the generated shared key with the previous shared key and multicasts the encrypted shared key to the SUB-MTU 22 or the RTU 23, and the SUB-MTU 22 or the RTU 23 receives the encrypted shared key, decrypts the encrypted shared key with the previous shared key and stores the decrypted shared key.

Next, a session key generating method for a SCADA system and a message communication method according to the present invention will be described.

In a message communication method according to the present invention, when a message is transmitted to a plurality of devices, the plurality of devices generate a session key using a key shared through a group key hierarchical structure, encrypt a message with the session key, and transmit the encrypted message. A session key is generated using a TVP which is a combination of a timestamp and a sequence number and a key shared between the devices which perform communication in a group key structure. The TVP is used to protect the session key from replay attacks. When a transmitting device i communicates with a receiving device group j, a session key SK_{i,j} is generated by hashing a shared key K_{u,v} and a TVP as in Equation 3:

SK_{i,j}=H(K_{u,v}, TVP) Equation 3.

When the transmitting device i communicates with one receiving device j, a session key SK_{i,j} is generated by hashing a shared key K_{u,v}, a TVP, an ID of a transmitting device, and an ID of a receiving device so that the session key in this case can be discriminated from the session key of Equation 3 as in Equation 4:

SK_{i,j}=H(K_{u,v}, IDᵢ, IDⱼ, TVP) Equation 4.

The method for generating a session key according to the present invention is not limited to Equations 3 and 4, and a session key can be generated by adding other elements to the above equations.

A message communication method according to the present invention can use the Iolus framework. When the Iolus framework is used, the amount of computation for message encryption can be reduced. A communication method to which the Iolus framework is applied is as follows. First, the MTU 21 serves as a group security controller (GSC), and the SUB-MTU 22 serves as a group security intermediary (GSI).

Therefore, all transmission messages are transmitted through the SUB-MTU 22. A transmitting device encrypts a message with a random key, encrypts the random key with the session key shared between the transmitting device and the SUB-MTU, and transmits the encrypted random key to the SUB-MTU 22. The SUB-MTU receives the encrypted messages and the encrypted random key, decrypts the encrypted random key with a session key shared with the transmitting device, re-encrypts the decrypted random key with a session key which is shared with a receiving device, and transmits the encrypted random key to the receiving device. At this time, if a session key is shared with a plurality of selected receiving devices through a group key hierarchical structure, only the selected receiving devices can decrypt the encrypted random key and decrypt the message with the decrypted random key.

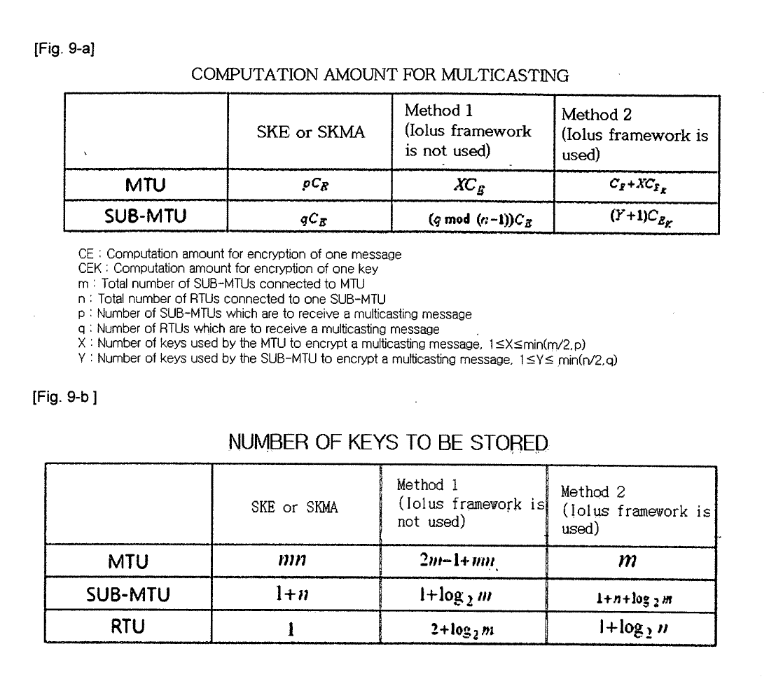

Next, effects of the shared key management method and the message communication method using the same according to the present invention will be described with reference to FIGS. 9A and 9B.

Using the shared key management method and the message communication method according to the present invention, as shown in FIGS. 9A and 9B, higher efficiency is obtained than by the SKE or SKMA methods. In FIGS. 9A and 9B, C_{E} denotes a computation amount for encryption of one message, C_{EK} denotes a computation amount for encryption of one key, p denotes the number of SUB-MTUs 22 which are to receive a multicasting message from the MTU, q denotes the number of RTUs 23 which are to receive a multicasting message, X denotes the number of keys used by the MTU 21 to encrypt a multicasting message and 1≦X≦min(m/2,p), and Y denotes the number of keys used by the SUB-MTU to encrypt a multicasting message and 123 Y≦min(n/2,q).

The present invention can be applied to development of a system through which an encrypted message is exchanged in a SCADA system. Particularly, the present invention is useful in developing an encrypted communication system through which an encrypted message is broadcast or multicast in a SCADA system.

As described above, the key management method for the SCADA system according to the present invention has the following advantages.

A computation amount for encrypting and broadcasting or multicasting a message can be reduced.

In the case where encrypted communication is performed through a SCADA communication device which has restricted memory space and computation ability, an encryption computation amount for broadcasting and multicasting communication is reduced. Therefore, the present invention is effective in a SCADA system which requires real-time processing, and since the number of keys to be stored is reduced, a key can be efficiently managed.

It will be apparent to those skilled in the art that various modifications can be made to the above-described exemplary embodiments of the present invention without departing from the spirit or scope of the invention. Thus, it is intended that the present invention cover all such modifications provided they come within the scope of the appended claims and their equivalents.

What is claimed is:

1. A shared key management method for a Supervisory Control And Data Acquisition (SCADA) system in which a master terminal unit (MTU), a plurality of sub master terminal units (SUB-MTUs), and a plurality of remote terminal units (RTUs) are configured in a sequential hierarchy, the method comprising:
(a) at the MTU, generating a plurality of secret keys and respectively allocating the secret keys to the RTUs;
(b) at the MTU, generating a group key in a tree structure, wherein a leaf node of the tree structure corresponds to each RTU, a parent node of a node corresponding to an RTU corresponds to a SUB-RTU to which the RTU is connected, a shared key of each node of the group key is generated by hashing shared keys of all child nodes, and a shared key of a leaf node of the group key is set as a secret key of the RTU;
(c) at the RTU or the SUM-MTU, receiving and storing shared keys of every node from a node corresponding to itself to a root node;
(d) when the RTU or the SUM-MTU is added or deleted, at the MTU, generating shared keys of nodes along a path from anode corresponding to the added or deleted terminal unit to the root node again; and
(e) at the RTU or the SUB-MTU, receiving and storing the generated shared keys.

2. The shared key management method of claim 1, wherein in step (a), the MTU generates a shared key and allocates the shared key to a SUB-MTU to which no RTU is connected, and in step (b), the SUB-MTU to which no RTU is connected corresponds to a leaf node of the tree structure.

3. The shared key management method of claim 1, wherein the tree structure is a binary tree up to a node corresponding to a SUB-MTU, and an n-array tree from the SUB-MTU to an RTU.

4. The shared key management method of claim 3, wherein step (d) comprises:
(d1) when the RTU is added or deleted, at a node corresponding to a SUB-MTU to which the added or deleted RTU is connected, adding or deleting a node corresponding to the added or deleted RTU;
(d2) when the SUB-MTU is added or deleted, adding or deleting a node corresponding to the added or deleted SUB-MTU to or from the tree structure of the group key and reconfiguring the tree structure of the group key as a binary tree; and
(d3) generating shared keys of nodes along a path from the added or deleted node to the root node again.

5. The shared key management method of claim 4, wherein, in step (d2),
when the SUB-MTU is added, the MTU generates a node corresponding to the added SUB-MTU, excludes one leaf node from the tree structure of the group key, generates an intermediate node which has the added node and the excluded leaf node as child nodes, and connects the intermediate node to a location at which the excluded leaf node is located before exclusion, and
when the SUB-MTU is deleted, the MTU deletes a node corresponding to the deleted SUB-MTU from the tree structure of the group key and places a sibling node of the deleted node at a location of a parent node of the deleted node.

6. The shared key management method of claim 1, where, in step (e), the MTU encrypts the generated shared key with a previous shared key and multicasts the encrypted shared key to the RTU or the SUB-MTU, and the RTU or the SUB-MTU receives and decrypts the encrypted shared key and stores the decrypted shared key.

7. A shared key management method for a Supervisory Control And Data Acquisition (SCADA) system in which a master terminal unit (MTU), a plurality of sub master terminal units (SUB-MTUs), and a plurality of remote terminal units (RTUs) are configured in a sequential hierarchy, the method comprising:
(a) at the MTU, generating a plurality of secret keys and respectively allocating the secret keys to the SUB-MTUs, and at the SUB-MTUs, generating a plurality of secret keys and respectively allocating the secret keys to the RTUs belonging to the SUB-MTUs;
(b) at the MTU, generating a group key of the SUB-MTUs in a tree structure, and at the SUB-MTUs, generating a group key of the RTUs belonging to the SUB-MTUs, wherein a leaf node of the tree structure corresponds to each RTU or each SUB-MTU, a shared key of each node of the group key is generated by hashing shared keys of all child nodes, and a shared key of a leaf node of the group key is set as a secret key of the RTU or the SUB-MTU;
(c) at the RTU or the SUM-MTU, receiving and storing shared keys of every node from a node corresponding to itself to a root node;
(d) when the RTU or the SUM-MTU is added or deleted, at the MTU or the SUB-MTU, generating shared keys of nodes along a path from a node corresponding to the added or deleted terminal unit to the root node again; and
(e) at the RTU or the SUB-MTU, receiving and storing the generated shared keys.

8. The shared key management method of claim 7, wherein the tree structure is a binary tree.

9. The shared key management method of claim 8, wherein step (d) comprises:
(d1) when the RTU or the SUB-MTU is added or deleted, adding or deleting a node corresponding to the added or deleted RTU or SUB-MTU to or from the tree structure of the group key and reconfiguring the tree structure of the group key as a binary tree; and
(d2) generating shared keys of nodes along a path from the added or deleted node to the root node again.

10. The shared key management method of claim 9, wherein, in step (d2),
when the SUB-MTU or the RTU is added, the MTU or the SUB-MTU generates a node corresponding to the added SUB-MTU or RTU, excludes one leaf node from the tree structure of the group key, generates an intermediate node which has the added node and the excluded leaf node as child nodes, and connects the intermediate node to a location a location at which the excluded leaf node is located before exclusion, and
when the SUB-MTU or the RTU is deleted, the MTU or the SUB-MTU deletes a node corresponding to the deleted SUB-MTU or RTU from the tree structure of the group key and places a sibling of the deleted node at a location of a parent node of the deleted node.

11. The shared key management method of claim 7, wherein, in step (e), the MTU or the SUB-MTU encrypts the generated shared key with a previous shared key and multicasts the encrypted shared key to the SUB-MTUs or the RTUs, and the SUB-MTU or the RTU receives and decrypts the encrypted shared key and stores the decrypted shared key.

12. A recording medium storing the shared key management method for the SCADA system according to any one of claims 1 to 11.

13. A session key generating method for a Supervisory Control And Data Acquisition (SCADA) system in which a master terminal unit (MTU), a plurality of sub master terminal units (SUB-MTUs), and a plurality of remote terminal units (RTUs) are configured in a sequential hierarchy, the method comprising:
generating a session key using a group key configured by the shared key management method according to one of claims 1 to 11.

14. The session key generating method of claim 13, wherein the session key is generated by hashing the group key and a value in which a timestamp and a sequence number are combined.

15. A message communication method for a Supervisory Control And Data Acquisition (SCADA) system in which a master terminal unit (MTU), a plurality of sub master terminal units (SUB-MTUs), and a plurality of remote terminal units (RTUs) are configured in a sequential hierarchy, the method comprising:
performing message communication between a group of the MTU and the SUB-MTUs and a group of the SUB-MTUs and the RTUs through an Iolus framework by using a group key configured by the shared key management method according to claim 1.

16. The message communication method of claim 15, wherein when the SUB-MTUs receive a message encrypted using a group key of the SUB-MTUs, the SUB-MTUs decrypt the encrypted message using a group key, encrypt the decrypted message using a shared key of a root node of a group key of RTUs belonging to the SUB-MTUs, and multicast the encrypted message to RTUs belonging to the SUB-MTUs.
